(19) United States
(12) Patent Application Publication
(10) Pub. No.: US 2026/0116706 A1
(43) Pub. Date: Apr. 30, 2026

(54) GEARLESS ELEVATOR DRIVE SYSTEM AND ELEVATOR SYSTEM COMPRISING A GEARLESS ELEVATOR DRIVE SYSTEM

(71) Applicant: Otis Elevator Company, Farmington, CT (US)

(72) Inventor: Santiago Gil, Madrid (ES)

(21) Appl. No.: 19/371,572

(22) Filed: Oct. 28, 2025

(30) Foreign Application Priority Data
Oct. 30, 2024 (EP) 24383192.2

(51) Int. Cl. B66B 11/04; B66B 1/34; B66B 1/36; B66B 11/00

(52) U.S. Cl. CPC B66B 11/0438; B66B 1/3492; B66B 1/36; B66B 11/004

(57) ABSTRACT

A gearless elevator drive system includes a rotatable shaft extending in an axial direction (A) between a first end and a second end of the shaft; an electric motor provided at a side adjacent to the first end of the shaft and coupled to the shaft for rotatably driving the shaft; at least one tension member coupling portion provided at a side adjacent to the second end of the shaft and configured for coupling the shaft with a tension member that is provided for suspending and driving an elevator car; a brake disc provided between the electric motor and the at least one tension member coupling portion and configured for rotating concurrently with the shaft; and at least one brake actuator including at least one brake shoe and configured for selectively urging the at least one brake shoe against the brake disc for braking the brake disc.

### FOREIGN PRIORITY

This application claims priority to European Patent Application No. 24383192.2, filed Oct. 30, 2024, and all the benefits accruing therefrom under 35 U.S.C. § 119, the contents of which in its entirety are herein incorporated by reference.

### TECHNICAL FIELD OF INVENTION

The invention relates to a gearless elevator drive system, in particular to a compact gearless elevator system, and to an elevator system comprising such a gearless elevator drive system.

### BACKGROUND OF THE INVENTION

An elevator system comprises at least one elevator car that is configured for moving along a hoistway extending between a plurality of landings and an elevator drive system that is configured for driving the at least one elevator car. The elevator system further comprises at least one tension member for suspending the at least one elevator car and for mechanically coupling the at least one elevator car with the elevator drive system.

The drive system may be installed in a machine room that is separated from the hoistway. Alternatively, in order to reduce the space occupied by the elevator system, the elevator system may be a machine room-less elevator system in which the elevator drive system is located in the hoistway.

It would be beneficial to provide a compact elevator drive system that occupies less space in the hoistway than a conventional elevator drive.

### SUMMARY OF THE INVENTION

Exemplary embodiments of the invention include a gearless elevator drive system that comprises a rotatable shaft extending in an axial direction between a first end and a second end of the shaft; an electric motor provided at a side adjacent to the first end of the shaft and coupled to the shaft for rotatably driving the shaft; and at least one tension member coupling portion provided at a side adjacent to the second end of the shaft for coupling the shaft with a tension member that is configured for suspending and driving an elevator car. In a gearless elevator drive system according to an exemplary embodiment of the invention, a brake disc is provided at the shaft at a position between the electric motor and the at least one tension member coupling portion. The brake disc is configured for rotating concurrently with the shaft. The gearless elevator drive system further comprises at least one brake actuator that includes at least one brake shoe and that is configured for selectively urging the at least one brake shoe against the brake disc for braking rotation of the brake disc and the shaft.

When viewed along the axial direction of the shaft, the at least one brake actuator is arranged at a side adjacent to the second end of the shaft and radially outside of the at least one tension member coupling portion.

Exemplary embodiments of the invention also include an elevator system comprising at least one elevator car that is configured for traveling in a hoistway between a plurality of landings; at least one tension member that is coupled to the at least one elevator car for suspending and driving the elevator car; and at least one gearless elevator drive system according to an exemplary embodiment of the invention. The at least one tension member coupling portion of the at least one gearless elevator drive system is coupled to the at least one tension member for supporting and driving the at least one tension member.

Arranging the at least one brake actuator at a side adjacent to the second end of the shaft and radially outside of the at least one tension member coupling portion allows for providing a compact elevator drive system that occupies less space than a conventional elevator drive system. As a result, the space that is available in the hoistway of an elevator system may be used more efficiently, e.g. for increasing the size of the elevator car. Alternatively, the size of the elevator car may remain constant and the dimensions of the hoistway may be reduced so that the elevator system occupies less space in the building in which it is installed.

By providing the elevator drive system as a gearless elevator drive system that does not comprise a gearing, the complexity, the volume, the weight and/or the costs of the elevator drive system may be reduced over an elevator drive system comprising a gearing.

In the following, a number of optional features of an elevator system according to exemplary embodiments of the invention are set out. These features may be realized in particular embodiments, alone or in combination with any of the other features, unless explicitly stated otherwise.

The gearless elevator drive system may comprise at least one machine frame and at least one bearing that is supported by the machine frame and configured for rotatably supporting the shaft. The at least one bearing may in particular be configured for rotatably supporting a central portion of the shaft that is located between the electric motor and the brake disc when viewed along the axial direction. The machine frame may be mounted to a stationary structure in the hoistway, for example to a side wall of the hoistway or to a bedplate that is provided in the hoistway.

Arranging the at least one bearing between the electric motor and the brake disc of the gearless elevator drive system allows for reducing the dimension of the gearless elevator drive system along the axial direction of the shaft even further.

The relatively short shaft of a gearless elevator drive system comprising at least one bearing supporting a central portion of the shaft allows for mounting the gearless elevator drive system in a cantilever structure at a side of the hoistway with the shaft extending perpendicularly from a wall of the hoistway towards a central portion of the hoistway.

Such a configuration allows for a very space saving installation of the gearless elevator drive system in the hoistway. It allows in particular for employing a cantilever suspension of the elevator car, in which the at least one tension member and the elevator car are supported from a side, in particular from a side wall, of the hoistway.

The at least one brake actuator may be arranged and configured so that it does not extend from its position adjacent to the second end of the shaft into an area located radially outside of the motor. The at least one brake actuator may in particular be arranged and configured so that is does not extend to the opposite side of the brake disc and/or to the opposite side of the machine frame. In other words, the at least one brake actuator may be arranged only on one side of the brake disc and the machine frame. This allows for reducing the dimensions of the gearless elevator drive system even further. It allows in particular for installing the gearless elevator drive system in a small space provided next to the path of the elevator car in the hoistway.

An elevator system according to an exemplary embodiment of the invention may further comprise at least one counterweight that is coupled to the at least one tension member and that is configured for moving in the hoistway concurrently and in opposite direction with respect to the elevator car.

Providing a counterweight may allow for reducing the load bearing capacity and the size of the elevator drive system even further, since the weight of the elevator car is at least partly compensated by the counterweight, reducing the maximum load that needs to be lifted by the elevator drive system.

An elevator system according to an exemplary embodiment of the invention may comprise at least two tension members that are coupled to the same gearless elevator drive system.

In order to allow for coupling the shaft with two or more tension members, at least two tension member coupling portions may be formed adjacent to the second end of the shaft. The two or more tension members may be formed next to each other along the axial direction of the shaft.

Employing two or more tension members for suspending the elevator car and a potential counterweight allows for distributing the load of the elevator car and the potential counterweight over a plurality of tension members. This allows for enhancing the safety of the elevator system through redundancy. It further allows for reducing the dimensions of each individual tension member compared to an elevator system comprising only a single tension member.

An elevator system according to an exemplary embodiment of the invention may comprise at least two gearless elevator drive systems and at least two tension members, wherein each of the at least two tension members is coupled to a tension member coupling portion of one of the at least two gearless elevator drive systems, respectively. Such a configuration allows for distributing the load of the elevator car between a plurality of tension members and elevator drive systems. In consequence, the dimensions of each of the elevator drive systems of such an elevator system may be reduced even further.

Two or more gearless elevator drive systems may be arranged on the same side of the elevator car. Two or more gearless elevator drive systems may in particular be arranged on the same support, for example on a common bedplate. By using a common support for supporting a plurality of gearless elevator drive systems, the two or more gearless elevator drive systems may be supported very efficiently at low costs.

The shafts of the two or more gearless elevator drive systems may extend parallel to each other perpendicularly to an adjacent wall of the hoistway towards a central portion of the hoistway, in particular forming a cantilever structure that allows for a space saving cantilever suspension of the elevator car.

In a further configuration, the at least two gearless elevator drive systems may be arranged on opposite sides of the elevator car. Arranging the at least two gearless elevator drive systems on opposite sides of the elevator car may allow for a symmetric configuration of the elevator system resulting in a symmetric distribution of the load of the elevator car.

The at least one tension member may be coupled to the at least one elevator car forming a 2:1 roping. Alternatively, the at least one tension member may be coupled to the elevator car forming a 4:1 roping. By employing a 2:1 roping or a 4:1 roping, the roping constitutes a reduction mechanism that allows for employing a fast rotating electric motor for moving the elevator car without the need of providing a reduction gear for reducing the rotational speed of the fast rotating motor.

In order to form a 2:1 roping or a 4:1 roping, the elevator system may comprise at least one pulley that is provided at a stationary support in the hoistway and/or at the elevator car that is configured for deflecting the at least one tension member.

The axes of the shaft and of the at least one pulley may extend parallel to each other. The axes may in particular extend perpendicularly to a sidewall of the hoistway adjacent to the elevator drive system.

When then axes of the shaft and of the at least one pulley extend perpendicularly to the adjacent sidewall of the hoistway, a 2:1 suspension or a 4:1 suspension of the elevator car may be implemented without twisting the tension member and without employing an underslung configuration.

The at least one tension member coupling portion that is formed on the shaft may be configured for coupling the shaft with a tension member that is provided in the form of a belt. The belt may in particular be a coated belt comprising a plurality of steel cords that are coated with a synthetic material.

The at least one tension member coupling portion may have a diameter in the range of between 80 mm and 90 mm, in particular a diameter in the range of between 84 mm and 86 mm.

Employing a belt as a tension member allows for reducing the diameter of the tension member coupling portion coupled with the belt compared to a configuration in which a rope is used as the tension member. This may allow for reducing the dimensions of the gearless elevator drive system even further.

A gearless elevator drive system according to an exemplary embodiment of the invention may further comprise an encoder that is configured for detecting a rotational position and/or a rotation of the shaft. Such an encoder may in particular allow for determining the current position of the elevator car in the hoistway by detecting the rotational position of the shaft. By detecting rotation of the shaft, it further allows for determining the speed of the elevator car moving along the hoistway. It in particular may allow for detecting an overspeeding of the elevator car.

The encoder may comprise an encoder pattern, in particular an encoder ring, that is configured for rotating concurrently with the shaft. The encoder may further comprise at least one stationary detector that is configured for detecting the encoder pattern. The encoder ring may be formed on or in the brake disc. Providing an encoder pattern, in particular an encoder ring, on or in the brake disc allows for providing a compact encoder that does not considerably add to the overall dimensions of the gearless elevator drive system. The encoder ring may also be formed on an encoder disc or ring that is attached to the shaft for rotating concurrently with the shaft.

The encoder pattern may be an optical pattern and the at least one stationary detector may be an optical detector that is configured for detecting the optical pattern formed in the brake disc.

The encoder pattern may also be a magnetic pattern and the at least one stationary detector may be a magnet detector that is configured for detecting the magnetic pattern formed in the brake disc.

The at least one brake actuator may comprise at least one elastic element, such as a spring, that is configured for urging the at least one brake shoe against the brake disc and at least one electric coil that is configured for attracting the at least one brake shoe for releasing the brake disc when an electric current flows through the at least one electric coil. Such a configuration provides a brake actuator that may reliably brake any movement of the elevator car, in particular in situations in which no electric power is supplied to the elevator system.

The at least one brake actuator may comprise at least one housing that houses components of the at least one brake actuator and/or of the at least one encoder. The at least one housing may further be configured for providing a tension member retainer for retaining at least one tension member that is coupled to the at least one tension member coupling portion formed on the shaft.

A housing that functions as a tension member retainer may enhance the safety of the elevator system. Providing an elevator system with a tension member retainer may be required by elevator safety codes, such as the EN81-20 elevator safety code. Employing a housing of at least one brake actuator as a tension member retainer may reduce the number of components of the elevator drive system. It may facilitate the assembly of the elevator drive system and/or allow for reducing the weight, the dimensions and/or the costs of the elevator drive system.

The gearless elevator drive system may have a length along the axial direction and a diameter along a radial direction that is oriented perpendicularly to the axial direction. The length may be equal to or smaller than the diameter.

The length of the gearless elevator drive system may be in the range of between 200 mm and 290 mm, in particular in the range of between 210 mm and 280 mm, for example 220 mm.

The diameter of the gearless elevator drive system may be in the range of between 200 mm and 250 mm, in particular in the range of between 210 mm and 230 mm, for example 220 mm.

### BRIEF DESCRIPTION OF THE DRAWINGS

In the following, exemplary embodiments of the invention are described in more detail with respect to the enclosed figures:

FIG. 1 depicts a schematic view of an upper portion of an elevator system according to an exemplary embodiment of the invention.

FIG. 2A depicts a schematic axial view of an elevator drive system according to an exemplary embodiment of the invention.

FIG. 2B depicts a schematic front view of the elevator drive system depicted in FIG. 2A.

FIG. 3A depicts a schematic plan view of an elevator drive system according to an exemplary embodiment of the invention that is equipped with two member coupling portions and a single machine frame.

FIG. 3B depicts a schematic plan view of another elevator drive system according to an exemplary embodiment of the invention that is equipped with two member coupling portions and two machine frames.

FIG. 3C depicts a schematic plan view of yet another elevator drive system according to an exemplary embodiment of the invention that is equipped with two member coupling portions and two machine frames.

FIG. 4A depicts a schematic side view of a cantilever type elevator system according to an exemplary embodiment of the invention employing a 2:1 roping.

FIG. 4B depicts a schematic plan view of the elevator system depicted in FIG. 4A.

FIG. 5A depicts a schematic side view of a cantilever type elevator system according to an exemplary embodiment of the invention comprising two elevator drive systems.

FIG. 5B depicts a schematic plan view of the elevator system depicted in FIG. 5A.

FIG. 6A depicts a schematic side view of a cantilever type counterweightless elevator system employing a 2:1 roping.

FIG. 6B depicts a schematic plan view of the elevator system depicted in FIG. 6A.

FIG. 7A depicts a schematic side view of an alternative embodiment of a counterweightless elevator system employing a 2:1 roping and comprising two gearless elevator drive systems.

FIG. 7B depicts a schematic plan view of the elevator system depicted in FIG. 7A.

FIG. 8A depicts a schematic side view of a further embodiment of a counterweightless elevator system employing a 2:1 roping.

FIG. 8B depicts a schematic plan view of the elevator system depicted in FIG. 8A.

FIG. 9A depicts a schematic side view of yet another exemplary embodiment of a cantilever type elevator system comprising two elevator drive systems that are arranged next to each other on the same side of the elevator car.

FIG. 9B depicts a schematic plan view of the elevator system depicted in FIG. 9A.

FIG. 10A depicts a schematic side view of an exemplary embodiment of a cantilever type elevator system in which a 4:1 roping is employed.

FIG. 10B depicts a schematic plan view of the elevator system depicted in FIG. 10A.

### DETAILED DESCRIPTION OF THE INVENTION

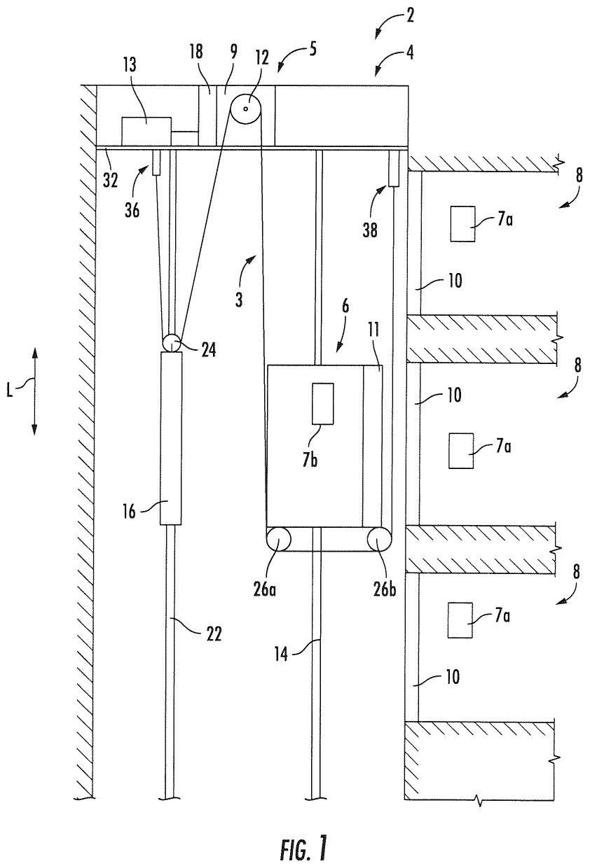

FIG. 1 depicts a schematic side view of an upper portion of an elevator system 2 according to an exemplary embodiment of the invention.

The elevator system 2 depicted in FIG. 1 comprises a hoistway 4 extending in a longitudinal direction LD between a plurality of landings 8 located on different floors.

The elevator system 2 includes an elevator car 6 arranged in the hoistway 4 for being moved along the longitudinal direction LD between the plurality of landings 8.

The elevator car 6 may in particular be movable along at least one elevator car guide member 14, such as at least one elevator car guide rail, provided in the hoistway 4 and extending along the longitudinal direction LD. Although only a single elevator car guide member 14 is visible in FIG. 1, the elevator system 2 may comprise a plurality of elevator car guide members 14 extending parallel to each other.

The longitudinal direction LD may be oriented in a vertical direction, as it is depicted in FIG. 1. In an alternative embodiment, which is not depicted in the figures, the longitudinal direction LD may be inclined with respect to the vertical direction.

For simplicity of the illustration, only a single elevator car 6 is depicted in FIG. 1. Exemplary embodiments of the invention may, however, also include elevator systems 2 comprising a plurality of elevator cars 6 moving in one or more hoistways 4.

A landing door 10 is provided at each of the landings 8. The elevator car 6 is provided with at least one corresponding elevator car door 11 for allowing passengers to transfer between a landing 8 and the interior of the elevator car 6, when the elevator car 6 is positioned at the respective landing 8.

The elevator car 6 is movably suspended by means of at least one tension member 3.

The at least one tension member 3 may be a rope, e.g. a steel cord, or a belt, in particular a belt comprising a plurality of steel cords (not shown).

The at least one tension member 3 may be uncoated. Alternatively, the at least one tension member 3 may be coated with a coating, e.g. with a coating having the form of a polymer jacket. The at least one tension member 3 may in particular be a belt comprising a plurality of polymer coated steel cords. The elevator system 2 may comprise a plurality of tension members 3 extending parallel to each other.

The at least one tension member 3 is coupled to a gearless elevator drive system 5. The gearless elevator drive system 5 comprises a rotatable shaft 12, an electric motor 9 for rotatably driving the shaft 12, and a drive 18 that harnesses and controls the supply of electrical energy to the electric motor 9. The gearless elevator drive system 5 is configured for driving the at least one tension member coupled to the shaft 12 for moving the elevator car 6 in the hoistway 4 along the longitudinal direction LD between the plurality of landings 8.

The elevator system 2 may further include a counterweight 16. The counterweight 16 may be coupled to the at least one tension member 3 and configured for moving in the hoistway 4 along at least one counterweight guide member 22 concurrently and in opposite direction with respect to the elevator car 6.

The gearless elevator drive system 5 is supported by a bedplate 32. The bedplate 32 may be made of cast iron, cast steel or a machined steel plate.

In the exemplary embodiment of an elevator system 2 depicted in FIG. 1, a 2:1 roping is employed. The skilled person easily understands that different kinds of roping, such as a 4:1 roping, may be employed as well.

The movement of the elevator car 6 along the hoistway 4 between the different landings 8 is controlled by an elevator controller 13.

Input to the elevator controller 13 may be provided via an elevator car control panel 7b provided inside the elevator car 6, and/or via landing control panels 7a provided on every landing 8, in particular in the vicinity of the landing doors 10.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled to the elevator controller 13 by means of electrical wiring not shown in FIG. 1, in particular by an electric bus, or by wireless data connections.

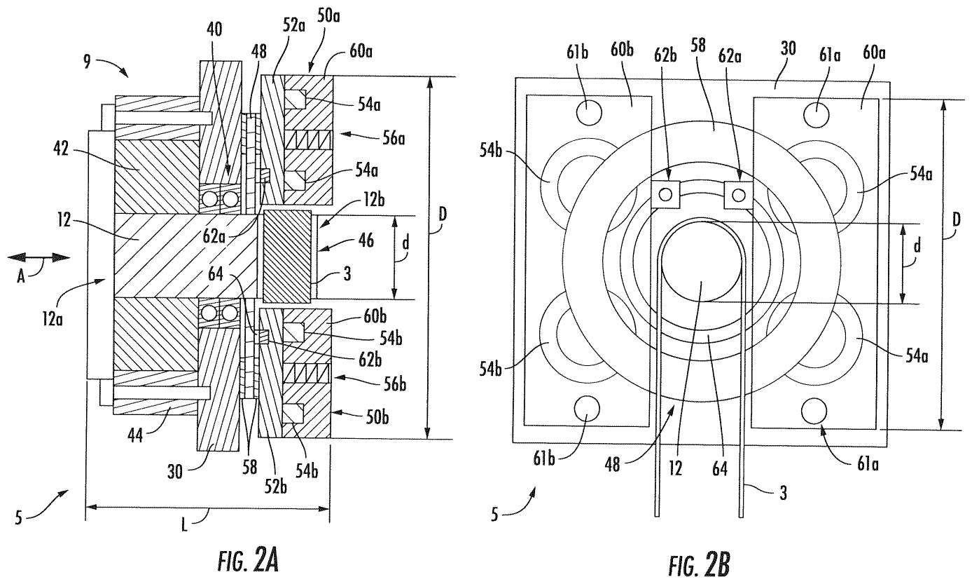

FIG. 2A depicts a schematic plan view of a gearless elevator drive system 5 according to an exemplary embodiment of the invention. FIG. 2B depicts a schematic front view of the gearless elevator drive system 5 depicted in FIG. 2A.

The gearless elevator drive system 5 comprises a machine frame 30 that may be mounted to a wall of the hoistway 4 or supported by a bedplate 32 provided in the hoistway 4, as it is depicted in FIG. 1.

The machine frame 30 supports at least one bearing 40 that is configured for rotatably supporting the shaft 12 of the gearless elevator drive system 5. The shaft 12 extends along an axial direction A that is oriented perpendicularly to the machine frame 30 in a horizontal direction.

A first end 12a of the shaft 12, which is depicted on the left side of the machine frame 30 in FIG. 2A, is coupled with a rotor 42 of the electric motor 9. The first end 12a of the shaft 12 and the rotor 42 are surrounded by a stator 44 of the electric motor 9 for being rotatably driven by the electric motor 9, when the electric motor 9 is activated. The stator 44 of the electric motor 9 may be supported by the machine frame 30.

A tension member coupling portion 46 is formed at an opposite second end 12b of the shaft 12, which is depicted on the right side of the machine frame 30 in FIG. 2A. The tension member coupling portion 46 couples the shaft 12 with the tension member 3 and serves as a traction sheave of the gearless elevator drive system 5.

The tension member coupling portion 46 may in particular be configured for coupling the shaft 12 with a tension member 3 having the form of a belt.

The at least one tension member coupling portion 46 may, for example, have a diameter d in the range of between 80 mm and 90 mm, in particular a diameter d in the range of between 84 mm and 86 mm.

In a gearless elevator drive system 5 according to an exemplary embodiment of the invention, no gearing is provided between the rotor 42 of the electric motor 9 and the tension member coupling portion 46. In consequence, the tension member coupling portion 46 rotates with the same rotational speed as the rotor 42.

By providing a gearless elevator drive system 5 that does not comprise a gearing, the complexity, the volume, the weight and/or the costs of the elevator drive system 5 may be reduced compared to an elevator drive system 5 that comprises a gearing for reducing the rotational speed of the traction member coupling portion 46 with respect to the rotor 42.

The gearless elevator drive system 5 further comprises a brake disc 48 that is coupled to the shaft 12 for rotating concurrently with the shaft 12, i.e. rotating with the same rotational speed as the shaft 12. The brake disc 48 may be mounted to the shaft 12. Alternatively, the brake disc 48 may be formed integrally with the shaft 12.

Two brake actuators 50a, 50b are provided on the side of the brake disc 48 facing away from the machine frame 30 so that the brake disc 48 is sandwiched between the machine frame 30 and the brake actuators 50a, 50b.

Each of the brake actuators 50a, 50b comprises at least one brake shoe 52a, 52b and at least one elastic element 56a, 56b, such as a spring, that is configured for urging the at least one brake shoe 52a, 52b against the brake disc 48 and squeezing the brake disc 48 between the respective brake shoe 52a, 52b and the machine frame 30 for braking any rotation of the brake disc 48 and the shaft 12.

At least one brake linings 58 may be provided on the brake disc 48 and/or on at least one portion of the machine frame 30 and the brake shoes 52a, 52b contacting the brake disc 48.

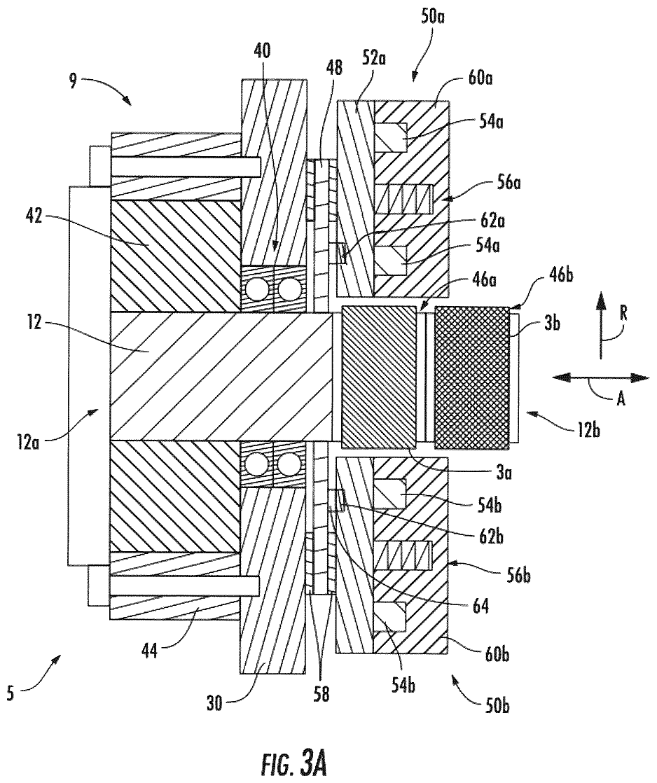

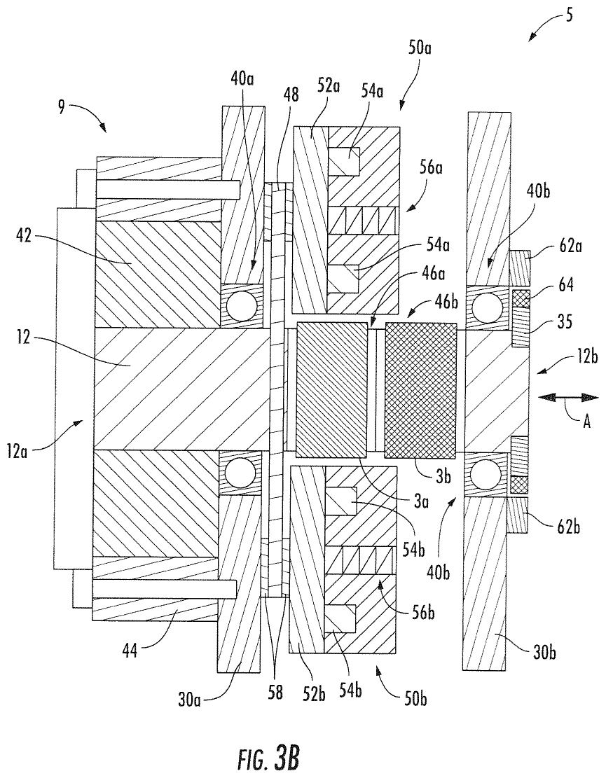

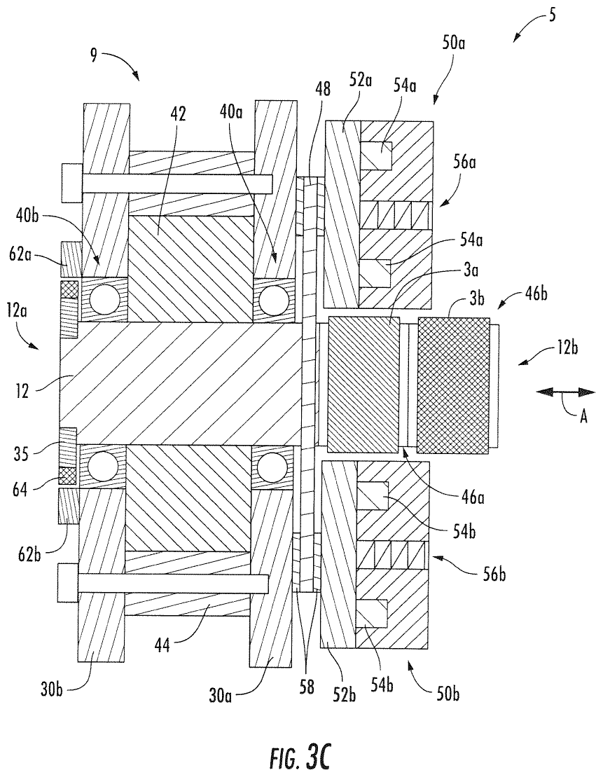

Each of the brake actuators 50a, 50b comprises at least one electric coil 54a, 54b. Each electric coil 54a, 54b is configured for releasing the brake disc 48 by attracting the respective brake shoe 52a, 52b of the corresponding brake actuator 50a, 50b against the elastic force applied by the respective elastic element 56a, 56b when an electric current flows through the corresponding electric coil 54a, 54b. In the exemplary embodiment depicted in FIGS. 2A, 2B, and 3, each brake actuator 50a, 50b is equipped with two electric coils 54a, 54b, respectively.

Each of the brake actuators 50a, 50b comprises an actuator case 60a, 60b that houses the respective at least one elastic element 56a, 56b and the respective electric coils 54a, 54b.

The actuator cases 60a, 60b may be configured such that they serve as a tension member retainer. The presence of tension member retainers may be required by elevator safety codes, for example by the EN81-20 elevator safety code.

The actuator cases 60a, 60b may be supported and fixed to the machine frame 30 by fastening members 61a, 61b, such as bolts, screw or rivets. Such fastening members 61a, 61b are not depicted in FIG. 2A.

When viewed along the axial direction A of the shaft 12, the brake actuators 50a, 50b are arranged at the same position as the at least one tension member coupling portion 46 that is formed at the second end 12b of the shaft 12. The brake actuators 50a, 50b are in particular arranged radially outside of the tension member coupling portion 46, as depicted in FIG. 2A.

When viewed along the axial direction A of the shaft 12, the brake actuators 50a, 50b do not extend to the opposite side of the brake disc 48 and to the opposite side of the machine frame 30, i.e. to the side that is shown on the left side in FIG. 2A. The brake actuators 50a, 50b do in particular not extend into a space that is located radially outside the electric motor 9.

A gearless elevator drive system 5 according to an exemplary embodiment of the invention may provide a compact gearless elevator drive system 5 that occupies only little space in the hoistway 4. A gearless elevator drive system 5 according to an exemplary embodiment of the invention may in particular have only a small length L in the axial direction A of the shaft 12 and/or a small extension D in a plane that is oriented perpendicularly to the axial direction A of the shaft 12.

An elevator drive system 5 according to an exemplary embodiment of the invention may, for example, have a length L in the axial direction A that is in the range of between 200 mm and 290 mm, in particular a length L that is in the range of between 210 mm and 280 mm, more particularly a length L of 220 mm.

An elevator drive system 5 according to an exemplary embodiment of the invention may, for example, have a basically cylindrical shape, for example a cylindrical shape having a diameter D in the range of between 200 mm and 250 mm, in particular a diameter D in the range of between 210 mm and 230 mm, more particularly a diameter D of 220 mm.

The length L of the gearless elevator drive system 5 in the axial direction A may in particular be equal to or smaller than its diameter D.

The gearless elevator drive system 5 may further be equipped with an encoder that allows for detecting a current rotational position and/or a rotation of the shaft 12.

The encoder may comprise an encoder pattern 64, in particular an encoder ring 64, that is formed on or in the brake disc 48, in particular on or in the surface of the brake disc 48 facing the brake actuators 50a, 50b.

The encoder ring 64 may be attached to the surface of the brake disc 48 facing the brake actuators 50a, 50b. Alternatively, the encoder ring 64 may be formed integrally in the brake disc 48.

The encoder further comprises at least one detector 62a, 62b that is configured for detecting the encoder pattern 64 formed on or in the brake disc 48 for determining the current rotational position of the shaft 12 with respect to the at least one detector 62a, 62b.

In the embodiments depicted in FIGS. 2A and 2B, the gearless elevator drive system 5 is equipped with two detectors 62a, 62b, with each of the detectors 62a, 62b being supported by one of the actuator cases 60a, 60b, respectively.

The encoder pattern 64 may be an optical encoder pattern 64 and the detectors 62a, 62b may be corresponding optical detectors 62a, 62b. The encoder pattern 64 may also be a magnetic encoder pattern 64 and the detectors 62a, 62b may be corresponding magnet detectors 62a, 62b.

Exemplary embodiments of the invention may further include elevator systems 2 comprising a plurality of tension members 3. In such embodiments, a plurality of tension member coupling portions 46a, 46b may be formed on the shaft 12.

FIG. 3A depicts an exemplary embodiment of a gearless elevator drive system 5 comprising two tension member coupling portions 46a, 46b. The two tension member coupling portions 46a, 46b are formed next to each other along the axial direction A at the second end 12 of the shaft 12.

FIG. 3B depicts another exemplary embodiment of a gearless elevator drive system 5 comprising two tension member coupling portions 46a, 46b.

The features of the gearless elevator drive system 5 depicted in FIG. 3B that are identical with the features of the embodiment depicted in FIG. 3A are denoted with the same reference signs and will not be discussed in detail again.

The description of these features provided above with reference to FIG. 3A correspondingly applies to the embodiment depicted in FIG. 3B.

The exemplary embodiment of the gearless elevator drive system 5 depicted in FIG. 3B comprises two machine frames 30a, 30b that are arranged in a configuration in which they are spaced apart from each other along the longitudinal axial direction A. The two machine frames 30a, 30b extend parallel to each other in planes that are oriented perpendicularly to the axial direction A.

A first machine frame 30a is arranged between the motor 9 and the brake disc 48, similar to the single machine frame 30 of the embodiment depicted in FIG. 3A.

A second machine frame 30b is arranged at the second end 12b of the shaft 12 facing away from the motor 9.

A bearing 40a, 40b rotatably supporting the shaft 12 is provided on each of the two machine frames 30a, 30b, respectively. In consequence, the two tension member coupling portions 46a, 46b formed on the shaft 12 are arranged between the two machine frames 30a, 30b in particular between the two bearings 40a, 40b supported by the machine frames 30a, 30b.

The brake disc 48 and the two brake actuators 50a, 50b are also arranged between the two bearings 40a, 40b and the machine frames 30a, 30b.

By rotatably supporting the shaft 12 at two positions that are spaced apart from each other along the axial direction A, the exemplary embodiment of a gearless elevator drive system 5 depicted in FIG. 3B provides additional stability that may allow for increasing the load bearing capacity of the gearless elevator drive system 5.

The exemplary embodiment of a gearless elevator drive system 5 depicted in FIG. 3B may additionally comprise an encoder disc or ring 35 that is attached to the second end 12b of the shaft 12 for rotating concurrently with the shaft 12. An encoder pattern 64, in particular an optical or magnetic encoder pattern, may be formed on the encoder disc or ring 35. In the exemplary embodiment depicted in FIG. 3B, the encoder pattern 64 is formed on the outer periphery of the encoder disc or ring 35.

Corresponding detectors 62a, 62b that are configured for detecting the encoder pattern 64 for determining the current rotational position of the shaft 12 are supported by the machine frame 30b that is arranged next to the encoder disc or ring 35.

In the exemplary embodiment depicted in FIG. 3B, the encoder disc or ring 35 and the corresponding detectors 62a, 62b are arranged on a side of the machine frame 30b opposite to the tension member coupling portions 46a, 46b. In an alternative embodiment, which is not explicitly depicted in the figures, the encoder disc or ring 35 and the corresponding detectors 62a, 62b may be provided on the other side of the machine frame 30b facing the brake actuators 50a, 50b. In other words, the encoder disc or ring 35 and the corresponding detectors 62a, 62b may be arranged between the tension member coupling portions 46a, 46b and the machine frame 30b.

FIG. 3C depicts yet another exemplary embodiment of a gearless elevator drive system 5 comprising two tension member coupling portions 46a, 46b and two machine frames 30a, 30b.

The features of the gearless elevator drive system 5 depicted in FIG. 3C that are identical with the features of the gearless elevator drive system 5 depicted in FIGS. 3A and 3B are denoted with the same reference signs and will not be discussed in detail again. The description of these features provided above with reference to FIGS. 3A and 3B correspondingly applies to the embodiment depicted in FIG. 3C.

The exemplary embodiment of a gearless elevator drive system 5 depicted in FIG. 3B also comprises two machine frames 30a, 30b extending parallel to each other and being spaced apart from each other along the axial direction A of the shaft 12.

Each of the two machine frames 30a, 30b is provided with a bearing 40a, 40b rotatably supporting the shaft 12, respectively.

The first machine frame 30a is arranged between the motor 9 and the brake disc 48, similar to the first machine frame 30a of the embodiment depicted in FIG. 3B.

Contrary to the embodiment depicted in FIG. 3B, the second machine frame 30b supporting the second bearing 40b is not arranged at the second end 12b of the shaft 12 on which the two tension member coupling portions 46a, 46b are formed, but at the first end 12a of the shaft 12 protruding from the rotor 42 of the electric motor 9.

As a result, the rotor 42 and the stator 44 of the electric motor 9 are arranged between the first and second machine frames 30a, 30b and between the first and second bearings 40a, 40b. Such a configuration may provide additional stability and rigidity for supporting a potentially heavy electric motor 9.

In the exemplary embodiment depicted in FIG. 5C, an encoder disc or ring 35 comprising an encoder pattern 64 is attached to the shaft 12 for rotating concurrently with the shaft 12. Corresponding detectors 62a, 62b that are configured for detecting the encoder pattern 64 for determining the current rotational position of the shaft 12 are supported by the second machine frame 30b.

In the exemplary embodiment depicted in FIG. 3C, the encoder disc or ring 35 and the corresponding detectors 62a, 62b are arranged on a side of the machine frame 30b opposite to the electric motor 9. In an alternative embodiment, which is not explicitly depicted in the figures, the encoder disc or ring 35 and the corresponding detectors 62a, 62b may be arranged on the other side of the machine frame 30b facing the electric motor 9. The encoder disc or ring 35 and the corresponding detectors 62a, 62b may in particular be arranged between the electric motor 9 and the machine frame 30b along the axial direction A.

Since the encoder disc or ring 35 and the corresponding detectors 62a, 62b have comparatively small dimensions in the axial direction A, providing the encoder disc or ring 35 and the corresponding detectors 62a, 62b adjacent to one of the ends 12a, 12b of the shaft 12, as it is depicted in FIGS. 3B and 3C, does not substantially add to the overall length L of the gearless elevator drive system 5 in the axial direction A.

Although the exemplary embodiments of gearless elevator drive systems 5 depicted in FIGS. 3B and 3C comprise two tension member coupling portions 46a, 46b, respectively, gearless elevator drive systems 5 according to exemplary embodiments of the invention comprising two machine frames 30a, 30b may alternatively include shafts 12 on which only a single tension member coupling portion 46 is formed, as depicted in FIG. 2A, or shafts 12 on which more than two tension member coupling portions 46a, 46b are formed.

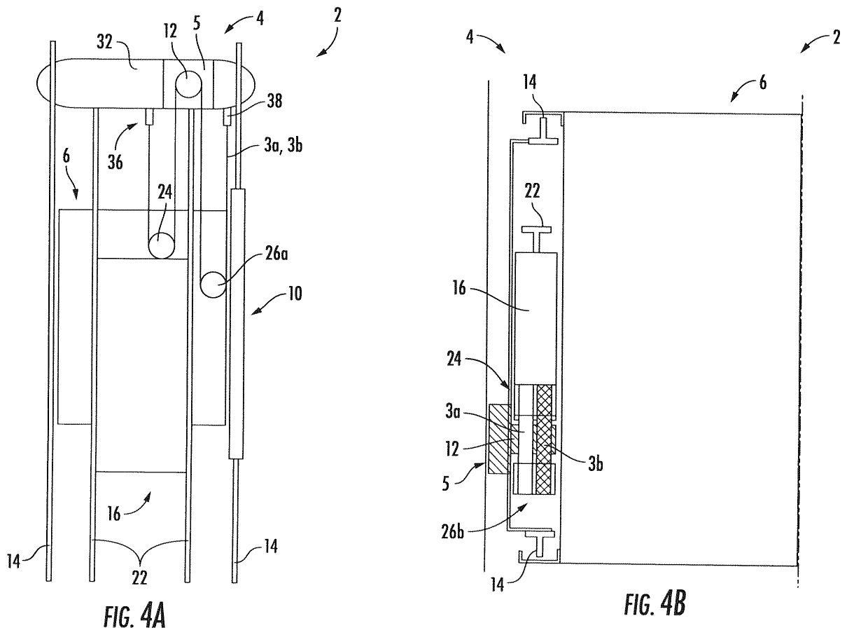

FIG. 4A depicts a schematic side view of an elevator system 2 comprising a compact gearless elevator drive system 5 according to an exemplary embodiment of the invention. FIG. 4B depicts a schematic plan view of the elevator system 2 depicted in FIG. 4A.

In the elevator system 2 depicted in FIGS. 4A and 4B, a 2:1 roping is employed for forming a cantilever type suspension for suspending the elevator car 6.

The elevator system 2 may comprise two tension members 3a, 3b extending parallel to each other. The two tension members 3a, 3b may be coupled the shaft 12 of the gearless elevator drive system 5 next to each other along the axial direction of the shaft 12, as it is depicted in FIGS. 3A to 3C.

Each of the tension members 3a, 3b forms a 2:1 roping and extends from a first tension member dead end hitch 36 supported by the bedplate 32 providing an upper stationary support in the vicinity of the top 4a of the hoistway 4 over a counterweight pulley 24 provided at the counterweight 16, the shaft 12 of the gearless elevator drive system 5, and an elevator car pulley 26a provided at the elevator car 6 to a second tension member dead end hitch 38 that is provided at the bedplate 32 in the vicinity of the top 4a of the hoistway 4.

The shaft 12 of the gearless elevator drive system 5 extends perpendicularly to an adjacent sidewall of the elevator car 6 and to an adjacent sidewall of the hoistway 4 next to the gearless elevator drive system 5. The axes of the pulleys 24, 26 are oriented parallel to the axial direction A of the shaft 12. This similarly applies to the further exemplary embodiments that are depicted in the following figures and described further below.

Since the axes of the shaft 12 and of the pulleys 24, 26 extend perpendicularly to the adjacent sidewall of the hoistway 4, a 2:1 roping for suspending the elevator car 6 may be implemented without twisting the tension member 3 and without employing an underslung configuration of the at least one tension member 3.

Due to the small dimensions of compact gearless elevator drive systems 5 according to exemplary embodiments of the invention, a plurality of compact elevator drive systems 5 may be installed next to each other in the hoistway 4.

FIG. 5A depicts a schematic side view of an elevator system 2 comprising two gearless elevator drive systems 5a, 5b and a 2:1 roping that is similar to the 2:1 roping depicted in FIGS. 4A and 4B. FIG. 5B depicts a schematic plan view of the elevator system 2 depicted in FIG. 5A.

In the embodiments depicted in FIGS. 4A, 4B, 5A and 5B, the shaft 12 of each gearless elevator drive system 5a, 5b is coupled with two tension members 3a, 3b, respectively. In further embodiments that are not explicitly depicted in the figures, the shaft 12 of each gearless elevator drive system 5a, 5b may be coupled with only a single tension member 3 or with more than two tension members 3a, 3b extending parallel to each other.

In an exemplary embodiment comprising two elevator drive systems 5a, 5b as it is depicted in FIGS. 5A and 5B, the load of the elevator car 6 may be distributed between the two elevator drive systems 5a, 5b. In consequence, the size of each of the elevator drive systems 5a, 5b may be reduced even further without reducing the maximum load bearing capacity of the elevator system 2.

Compact gearless elevator drive systems 5, 5a, 5b according to exemplary embodiments of the invention may also be employed in counterweightless elevator systems 2, i.e. in elevator systems 2 that do not comprise a counterweight 16.

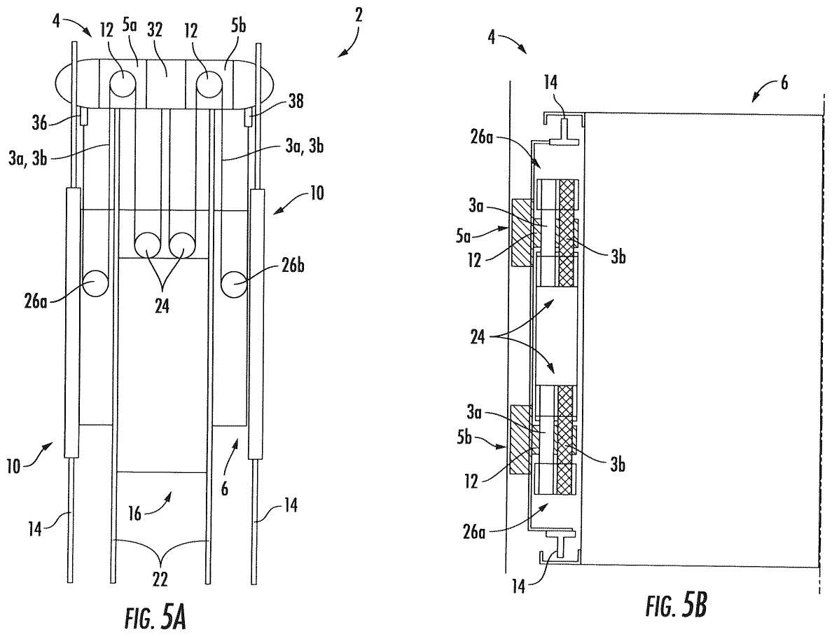

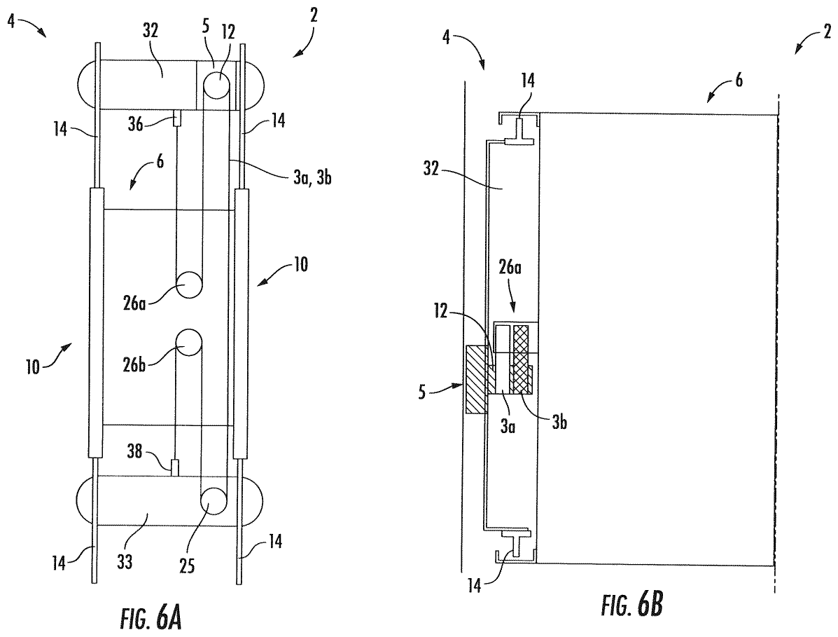

Exemplary embodiments of such counterweightless elevator systems 2 are depicted in FIGS. 6A to 10B.

FIG. 6A depicts a schematic side view of a counterweightless elevator system 2. FIG. 6B depicts a schematic plan view of the elevator system 2 depicted in FIG. 6A.

The exemplary embodiment of a counterweightless elevator system 2 depicted in FIGS. 6A and 6B comprises two tension members 3a, 3b extending parallel to each other between a first tension member dead end hitch 36 that is provided in the vicinity of the top 4a of the hoistway 4 and a second tension member dead end hitch 38 that is provided at a lower stationary support 33 in the vicinity of the bottom 4b the hoistway 4.

The tension members 3a, 3b are deflected by the shaft 12 of the gearless elevator drive system 5, by first and second elevator car pulleys 26a, 26b provided at the elevator car 6, and by a lower deflection pulley 25 provided at the lower stationary support 33, forming in a 2:1 roping.

Although two tension members 3a, 3b extending parallel to each other are depicted in FIGS. 6A and 6B, an elevator system comprising a 2:1 roping, as it is depicted in FIGS. 6A and 6B, may alternatively comprise only a single tension member 3 or more than two tension members 3a, 3b extending parallel to each other.

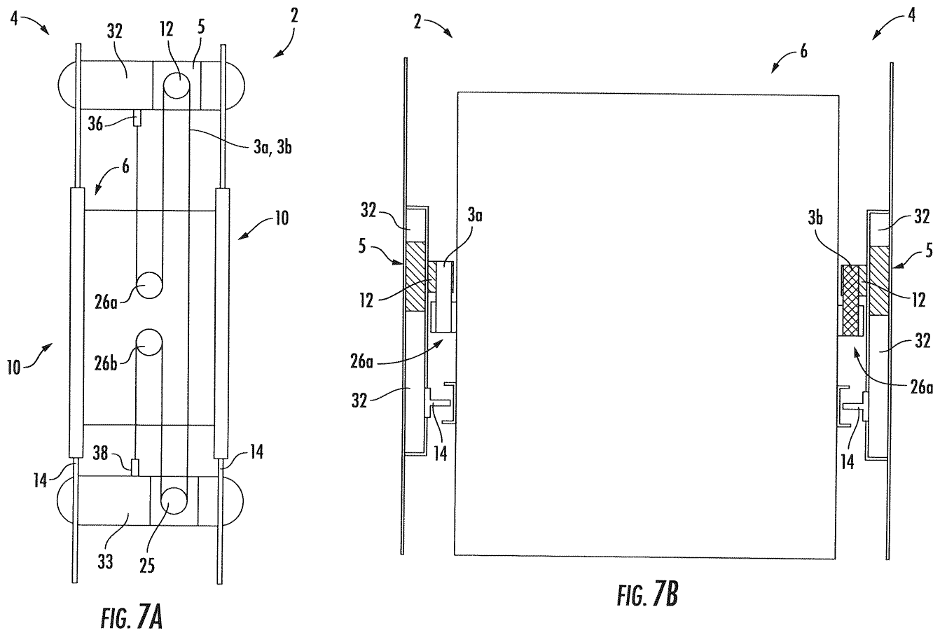

FIG. 7A depicts a schematic side view of an alternative embodiment of a counterweightless elevator system 2 employing a 2:1 roping. FIG. 7B depicts a schematic plan view of the elevator system 2 depicted in FIG. 7A.

The 2:1 roping employed in the embodiment depicted in FIGS. 7A and 7B is similar to the 2:1 roping employed in embodiment depicted in FIGS. 6A and 6B. In the embodiment depicted in FIGS. 7A and 7B, the elevator car 6 is suspended by a symmetrical configuration of tension members 3a, 3b instead of the cantilever suspension depicted in FIGS. 6A and 6B. In particular, a single tension member 3a, 3b extending between the bedplate 32 that is located in the vicinity of the top 4a of the hoistway 4 and a lower stationary support 33 that is located in the vicinity of the bottom 4b the hoistway 4 is provided on each side of the elevator car 6, respectively.

A compact gearless elevator drive system 5a, 5b is arranged on each of two opposite sides of the elevator car 6, respectively. The shaft 12 of each compact gearless elevator drive system 5a, 5b is coupled with the respective tension member 3a, 3b for driving the elevator car 6.

The shafts 12 of the two elevator drive systems 5a, 5b extend parallel to each other and perpendicularly to the adjacent sidewalls of the elevator car 6 and the hoistways 4.

In an exemplary embodiment as it is depicted in FIGS. 7A and 7B, the load of the elevator car 6 is distributed between the two elevator drive systems 5a, 5b. In consequence, the load bearing capacity and the size of each of the two elevator drive systems 5a, 5b may be reduced even further compared to the gearless elevator drive system 5 of an elevator system 2 comprising only a single gearless elevator drive system 5 without reducing the maximum load bearing capacity of the elevator system 2.

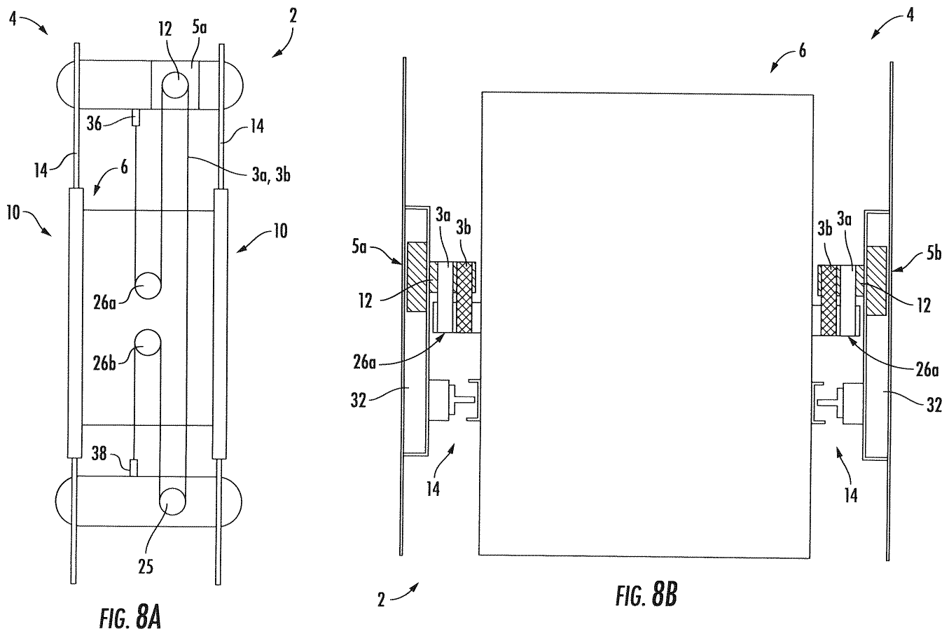

FIG. 8A depicts a schematic side view of a further embodiment of a counterweightless elevator system 2 employing a 2:1 roping. FIG. 8B depicts a schematic plan view of the elevator system 2 depicted in FIG. 8A.

Similar to the embodiment depicted in FIGS. 7A and 7B, in the exemplary embodiment depicted in FIGS. 8A and 8B, a gearless elevator drive system 5a, 5b is provided on each of two opposite sides of the elevator car 6, respectively.

Contrary to the exemplary embodiment depicted in FIGS. 7A and 7B, two tension members 3a, 3b are coupled to the shaft 12 of each of the two gearless elevator drive systems 5a, 5b, respectively.

The two tensions members 3a, 3b that are coupled to each of the shafts 12 extend parallel to each other between the bedplate 32 providing an upper stationary support and the lower stationary support 33, as is has been described with respect to the embodiment depicted in FIGS. 6A and 6B.

In an elevator system 2 comprising four tension members 3a, 3b, as it is depicted in FIGS. 8A and 8B, the necessary maximum load bearing capacity of each of the tension members 3a, 3b may be reduced compared to the embodiment depicted in FIGS. 7A and 7B without reducing the maximum load bearing capacity of the elevator system 2.

Although it is not explicitly shown in the figures, further embodiments of an elevator system 2 as it is depicted in FIGS. 8A and 8B may comprise more than four tension members 3a, 3b. A configuration comprising additional tension members 3a, 3b may allow for reducing the load bearing capacity of each of the tension members 3a, 3b even further without reducing the maximum load bearing capacity of the elevator system 2.

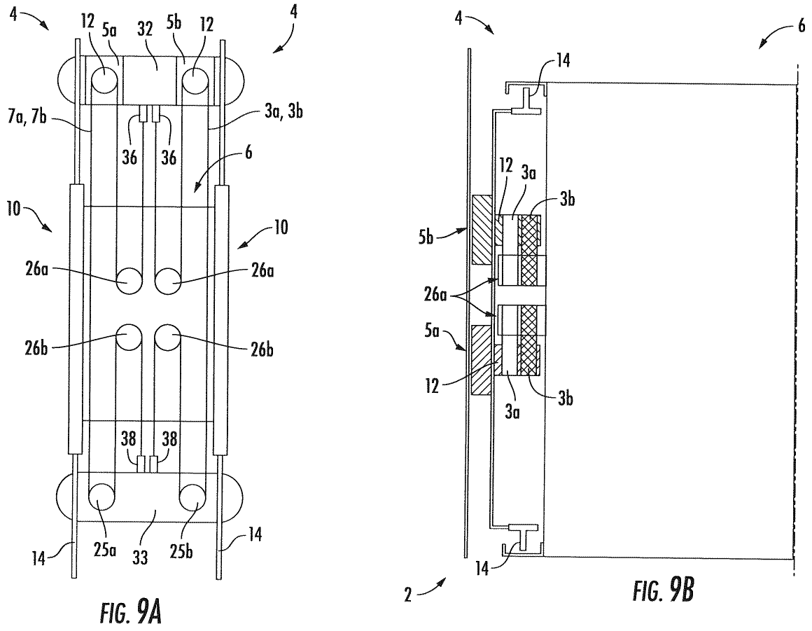

FIG. 9A depicts a schematic side view of yet another exemplary embodiment of an elevator system 2 in which two elevator drive systems 5a, 5b are arranged on the same side of the elevator car 6 next to each other. The two elevator drive systems 5a, 5b may in particular be arranged on a common bedplate 32. FIG. 9B depicts a schematic plan view of the elevator system 2 depicted in FIG. 9A.

The elevator system 2 depicted in FIGS. 9A and 9B employs a cantilever structure and a 2:1 roping.

Each of the two gearless elevator drive systems 5a, 5b is coupled with a respective pair of tension members 3a, 3b extending between the bedplate 32 providing an upper stationary support and the lower stationary support 33, respectively.

Each of the tension members 3a, 3b extends from a first tension member dead end hitch 36 provided at the bedplate 32 in the vicinity of the top 4a of the hoistway 4 to a second tension member dead end hitch 38 provided at the lower stationary support 33 along a path extending over the shaft 12 of one of the elevator drive systems 5a, 5b, two elevator car pulleys 26a, 26b mounted to the elevator car 6, and a lower deflection pulley 25 that is provided at the lower stationary support 33.

Since in the exemplary embodiment depicted in FIGS. 9A and 9B, the elevator drive systems 5a, 5b and the tension members 3a, 3b are arranged only on one side of the elevator car 6, the width of the hoistway 4 may be reduced compared to the width of the hoistway 4 of the elevator system 2 depicted in FIGS. 8A and 8B, when the width of the elevator car 6 remains constant.

Alternatively, the width of the hoistway 4 may remain constant and the width of the elevator car 6 may be increased.

In any case, the space that is available in the hoistway 4 of the elevator system 2 may be used more efficiently for transporting passengers and/or goods, when the elevator drive systems 5a, 5b and the tension members 3a, 3b are arranged on only one side of the elevator car 6.

In further embodiments that are not explicitly depicted in the figures, only a single tension member 3a, 3b or more than two tension members 3a, 3b extending parallel to each other may be coupled to each of the gearless elevator drive systems 5a, 5b, respectively.

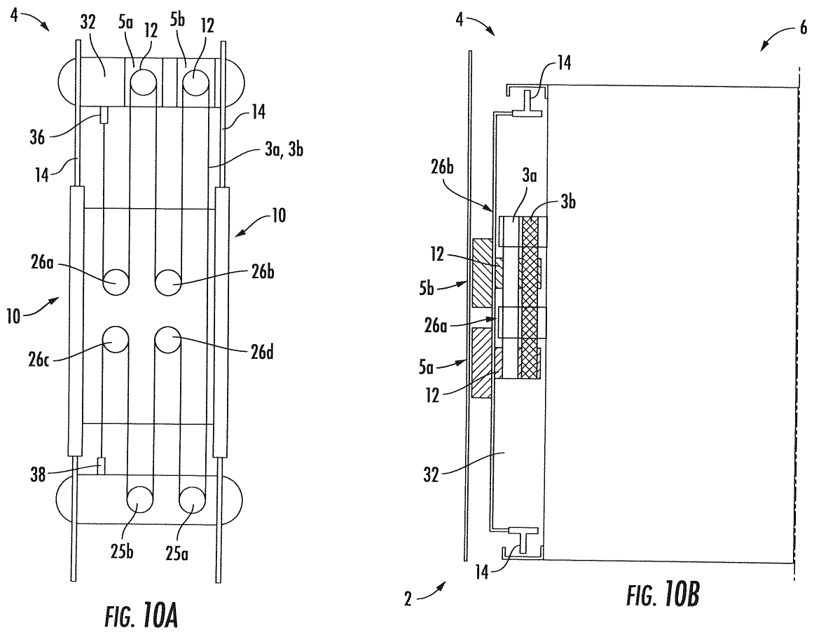

FIG. 10A depicts a schematic side view of an exemplary embodiment of an elevator system 2, in which a 4:1 roping is employed. FIG. 10B depicts a schematic plan view of the elevator system 2 depicted in FIG. 10A.

Similar to the embodiment depicted in FIGS. 9A and 9B, the elevator system 2 depicted in FIGS. 10A and 10B employs a cantilever structure and a 2:1 roping.

The exemplary embodiment of an elevator system 2 depicted in FIGS. 10A and 10B comprises two elevator drive systems 5a, 5b that are arranged next to each other on the same side of the elevator car 6. The two elevator drive systems 5a, 5b may, for example, be arranged on a common bedplate 32 in the vicinity of the top 4a of the hoistway 4.

The elevator system 2 further comprises a two tension members 3a, 3b. The two tension members 3a, 3b are arranged next to each other along the axial direction of each of the shafts 12 of the two elevator drive systems 5a, 5b.

Each of the tension members 3a, 3b extends from a first tension member dead end hitch 36 provided at the bedplate 32 providing an upper support in the vicinity of the top 4a of the hoistway 4 to a second tension member dead end hitch 38 provided at the lower stationary support 33.

Each of the tension members 3a, 3b extends in particular from the first tension member dead end hitch 36 over a first elevator car pulley 26a provided at the elevator car 6, the shaft 12 of the first gearless elevator drive system 5a, a second elevator car pulley 26b provided at the elevator car 6, the shaft 12 of the second gearless elevator drive system 5b, a first lower deflection pulley 25a, a third elevator car pulley 26c, a second lower deflection pulley 25b, and a fourth elevator car pulley 26d to the second tension member dead end hitch 38.

Employing a 4:1 roping as depicted in FIGS. 10A and 10B allows for lifting very heavy loads using compact elevator drive systems 5a, 5b.

The axes of the shafts 12 and of the pulleys 24, 26 extend perpendicularly to the adjacent sidewall of the hoistway 4. As a result, the 4:1 suspension of the elevator car 6 may be implemented without twisting the tension members 3a, 3b and without employing an underslung configuration.

Although the elevator system 2 depicted in FIGS. 10A and 10B comprises two tension members 3a, 3b, an elevator system 2 employing a 4:1 roping may alternatively comprise only a single tension member 3a, 3b or more than two tension members 3a, 3b extending parallel to each other.

Although the elevator system 2 depicted in FIGS. 10A and 10B comprises two gearless elevator drive systems 5a, 5b, an elevator system 2 employing a 4:1 roping may alternatively comprise only a single gearless elevator drive system 5.

In another embodiment that is not explicitly depicted in the figures, the elevator system 2 may comprise at least one additional elevator drive system (not shown) comprising a shaft that replaces at least one of the lower deflection pulleys 25a, 25b.

In yet another embodiment that is not explicitly depicted in the figures, a 4:1 roping may be provided on both sides of the elevator car 6, similar to the embodiments depicted in FIGS. 7A to 8B. Such a configuration may allow for enhancing the maximum load bearing capacity of the elevator system 2 even further. It may also allow for reducing the load bearing capacity of each of the tension members 3a, 3b, respectively.

The exemplary embodiments of elevator systems 2 depicted in FIGS. 4A and 10B are depicted only as examples of elevator systems 2 employing compact gearless elevator drive systems 5, 5a, 5b according to exemplary embodiments of the invention.

The exemplary embodiments depicted in FIGS. 4A and 10B do not restrict the use of gearless elevator drive systems 5, 5a, 5b according to exemplary embodiments of the invention to the depicted types of elevator systems 2. In other words, gearless elevator drive systems 5, 5a, 5b according to exemplary embodiments of the invention may also be employed in other types of elevator systems 2 that are not explicitly depicted in the figures.

In alternative embodiments that are not explicitly depicted in the figures, the bedplate 32 and the at least one gearless elevator drive system 5, 5a, 5b may, for example, be arranged in the vicinity of the bottom 4b of the hoistway 4, and at least one deflection pulley 25, 25a, 25b may be an upper deflection pulley that is supported by an upper stationary support provided in the vicinity of the top 4a of the hoistway 4.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. A gearless elevator drive system (5, 5a, 5b) comprising:
a rotatable shaft (12) extending in an axial direction (A) between a first end (12a) and a second end (12b) of the shaft (12);
an electric motor (9) provided at a side adjacent to the first end (12a) of the shaft (12) and coupled to the shaft (12) for rotatably driving the shaft (12);
at least one tension member coupling portion (46; 46a, 46b) provided at a side adjacent to the second end (12b) of the shaft (12) and configured for coupling the shaft (12) with a tension member (3; 3a, 3b) that is provided for suspending and driving an elevator car (6);
a brake disc (48) provided at the shaft (12) between the electric motor (9) and the at least one tension member coupling portion (46; 46a, 46b) and configured for rotating concurrently with the shaft (12); and
at least one brake actuator (50a, 50b) comprising at least one brake shoe (52a, 52b) and configured for selectively urging the at least one brake shoe (52a, 52b) against the brake disc (48) for braking the brake disc (48);
wherein, when viewed along the axial direction (A), the at least one brake actuator (50a, 50b) is arranged at a side adjacent to the second end (12b) of the shaft (12), and
wherein the at least one brake actuator (50a, 50b) is arranged radially outside of the at least one tension member coupling portion (46; 46a, 46b).

2. The gearless elevator drive system (5, 5a, 5b) according to claim 1,
wherein the at least one brake actuator (50a, 50b) does not extend along the axial direction (A) into an area that is located radially outside of the electric motor (9);
wherein the at least one brake actuator (50a, 50b) does in particular not extend onto an opposite side of the brake disc (48).

3. The gearless elevator drive system (5, 5a, 5b) according to claim 1, further comprising at least one machine frame (30; 30a, 30b) and at least one bearing (40; 40a, 40b) that is configured for rotatably supporting the shaft (12), in particular for rotatably supporting a central portion of the shaft (12) that is located between the electric motor (9) and the brake disc (48) when viewed along the axial direction (A).

4. The gearless elevator drive system (5, 5a, 5b) according to claim 1, wherein the shaft (12) comprises at least two tension member coupling portions (46a, 46b).

5. The gearless elevator drive system (5, 5a, 5b) according to claim 1,
wherein the at least one tension member coupling portion (46; 46a, 46b) is configured for coupling the shaft (12) with a tension member (3; 3a, 3b) having the form of a belt;
wherein the at least one tension member coupling portion (46; 46a, 46b) has in particular a diameter (d) in the range of between 80 mm and 90 mm.

6. The gearless elevator drive system (5, 5a, 5b) according to claim 1, further comprising an encoder that is configured for detecting a rotational position and/or a rotation of the shaft (12).

7. The gearless elevator drive system (5, 5a, 5b) according to claim 6, wherein the encoder comprises an encoder pattern (64), in particular an encoder ring (64) that is configured for rotating concurrently with the shaft (12), and at least one stationary detector (62a, 62b) that is configured for detecting the encoder pattern (64).

8. The gearless elevator drive system (5, 5a, 5b) according to claim 1, wherein the gearless elevator drive system (5) has a length (L) along the axial direction (A) and a diameter (D) along a radial direction that is oriented perpendicularly to the axial direction (A),
wherein the length (L) is equal to or smaller than the diameter (D);
wherein the length (L) is in particular in the range of between 200 mm and 290 mm, more particularly in the range of between 210 mm and 280 mm, for example of 220 mm; and/or
wherein the diameter (D) is in particular in the range of between 200 mm and 250 mm, more particularly in the range of between 210 mm and 230 mm, for example of 220 mm.

9. The gearless elevator drive system (5, 5a, 5b) according to claim 1,
wherein the at least one brake actuator (50a, 50b) comprises a housing (60a, 60b);
wherein the housing (60a, 60b) is in particular formed so that it provides a tension member retainer for retaining a tension member (3; 3a, 3b) that is coupled to the at least one tension member coupling portion (46; 46a, 46b) formed on the shaft (12).

10. An elevator system comprising:
at least one elevator car (6) that is configured for traveling in a hoistway (4) between a plurality of landings (8);
at least one tension member (3; 3a, 3b) that is coupled to the at least one elevator car (6) for suspending and driving the elevator car (6); and
at least one gearless elevator drive system (5, 5a, 5b) according to claim 1;
wherein the at least one tension member coupling portion (46; 46a, 46b) of the at least one gearless elevator drive system (5, 5a, 5b) is coupled to the at least one tension member (3; 3a, 3b) for supporting and driving the at least one tension member (3; 3a, 3b);
wherein the shaft (12) of the at least one gearless elevator drive system (5, 5a, 5b) extends in particular perpendicularly to an adjacent side wall of the elevator car (6) and orthogonally to an adjacent sidewall of the hoistway (4).

11. The elevator system according to claim 10 comprising at least two tension members (3a, 3b) that are coupled to the same gearless elevator drive system (5, 5a, 5b).

12. The elevator system according to claim 10 comprising at least two gearless elevator drive systems (5, 5a, 5b) and at least two tension members (3a, 3b), wherein each of the at least two tension members (3a, 3b) is coupled to a tension member coupling portion (46; 46a, 46b) of one of the at least two gearless elevator drive systems (5, 5a, 5b), respectively.

13. The elevator system according to claim 12,
wherein the at least two gearless elevator drive systems (5, 5a, 5b) are arranged on opposite sides of the elevator car (6); or
wherein the at least two gearless elevator drive systems (5, 5a, 5b) are arranged on the same side of the elevator car (6), wherein the at least two gearless elevator drive systems (5, 5a, 5b) are in particular arranged on a common bedplate (32).

14. The elevator system according to claim 10,
wherein the at least one tension member (3; 3a, 3b) is coupled to the at least one elevator car (6) forming a 2:1 roping, or
wherein the at least one tension member (3; 3a, 3b) is coupled to the elevator car (6) forming a 4:1 roping;
wherein the at least one tension member (3; 3a, 3b) is in particular not underslung below the elevator car (6).

15. The elevator system according to claim 10, further comprising
at least one deflection pulley (25; 25a, 25b) that is provided at a stationary support (33) in the hoistway (4) for deflecting the at least one tension member (3; 3a, 3b); and/or
at least one elevator car pulley (26a, 26b) that is provided at the elevator car (6) for deflecting the at least one tension member (3; 3a, 3b); and/or
at least one counterweight (16) that is coupled to the at least one tension member (3; 3a, 3b) and configured for moving in the hoistway (4) concurrently and opposite direction with respect to the elevator car (6)
wherein the axes of the at least one deflection pulley (25; 25a, 25b) and/or of the at least one elevator car pulley (26a, 26b) extend in particular parallel to the axis of the shaft (12) of the at least one gearless elevator drive system (5, 5a, 5b).
